(19) United States
(12) Patent Application Publication
(10) Pub. No.: US 2014/0271035 A1
(43) Pub. Date: Sep. 18, 2014

(54) SCREW MADE OF HIGH-STRENGTH COMPOSITE MATERIAL AND HIGH-STRENGTH CAPPED SCREW MADE OF HIGH-STRENGTH COMPOSITE MATERIAL

(71) Applicant: TING-JUI WANG, New Taipei City (TW)

(72) Inventor: TING-JUI WANG, New Taipei City (TW)

(21) Appl. No.: 13/826,728

(22) Filed: Mar. 14, 2013

(51) Int. Cl. F16B 35/00

(52) U.S. Cl. CPC F16B 35/00
USPC 411/424

(57) ABSTRACT

A screw made of a high-strength composite material includes a head with a first end, a second end, and a first containing portion in the head and having an opening at the second end of the head which is made of a first material like plastic, fiber, rubber or silicone; a thread, with a first end, a second end, and a second containing portion in the thread and having an opening at the first end of the thread, and the first end of the thread being coupled to the second end of the head, and the first containing portion of the head and the second containing portion of the thread forming a space, and the thread being made of the first material; and an enhanced post body contained in the first and second containing portions and made of a second material like metal.

### FIELD OF THE INVENTION

The present invention relates to a plastic screw, in particular to the screw made of a high-strength composite material and having a durable joint between a head and a thread of the screw to enhance the overall structural strength of the screw.

### BACKGROUND OF THE INVENTION

Conventional plastic screws with the features of high insulation, chemical resistance, acid and alkali resistances and electrostatic resistance and low thermal conduction are generally used in different environments and equipments. For example, the plastic screws are used extensively in LCD equipments to avoid the problems caused by electrostatic charges.

Most plastic screws are made of plastic, fiber, ceramic or rubber, so that the torque and shear of the screws are insufficient to meet the general requirements. When a user turns the plastic screw, the head and the thread of the screw may be cracked or broken easily due to the insufficient torque or fractured due to the insufficient shear. Therefore, these plastic screws cannot be used extensively in different areas.

In addition, the conventional plastic screws have a simple structure and usually come with a head and a thread, and thus they cannot meet different users' requirements.

Therefore, it is a main subject for related manufacturers to develop a plastic screw with an enhanced joint between the head and the thread of the screw to overcome the problem of damaging, cracking or breaking the plastic screws easily.

### SUMMARY OF THE INVENTION

It is a primary objective of the present invention to provide a screw made of a high-strength composite material in order to overcome the aforementioned drawback of the conventional plastic screw having insufficient torque and shear and causing damages or cracks of the plastic screw easily when users turn the plastic screw.

To achieve the aforementioned and other objectives, the present invention provides a screw made of a high-strength composite material, comprising: a head, with a first end, a second end, and a first containing portion disposed in the head, wherein an opening of the first containing portion is formed at the second end of the head, and the head is made of a first material which is plastic, fiber, rubber and or silicone; a thread, with a first end, a second end, and a second containing portion disposed in the thread, wherein an opening of the second containing portion is formed at the first end of the thread, and the first end of the thread is coupled to the second end of the head, and the first containing portion of the head and the second containing portion of the thread form a space, and the thread is made of the first material; and an enhanced post body, contained in the first containing portion and the second containing portion, and made of a second material which is a metal.

In a preferred embodiment of the present invention, the head further includes an operating portion disposed at the top of the head and interconnected with the first end and the first containing portion of the head.

In a preferred embodiment of the present invention, the screw made of a high-strength composite material further comprises a rod with a first end, a second end, and a receiving channel interconnected with the first end and the second end, wherein the second end of the head is coupled to the first end of the rod, and the second end of the rod is coupled to the first end of the thread, and the first containing portion, the receiving channel and the second containing portion form a space, and the rod is made of the first material, and the enhanced post body is contained in the first containing portion, the receiving channel and the second containing portion.

In a preferred embodiment of the present invention, the enhanced post body further includes an enhanced head disposed at the top of the enhanced post body, and the enhanced head is disposed in the first containing portion, disposed inside the operating portion, or protruded from the first end of the head.

In a preferred embodiment of the present invention, the enhanced head further includes an enhanced operating portion disposed at the top of the enhanced head.

In a preferred embodiment of the present invention, the enhanced post body further includes an enhanced operating portion disposed at the top of the enhanced post body.

In a preferred embodiment of the present invention, the enhanced operating portion is disposed in the first containing portion, contained inside the operating portion, or protruded from the first end of the head.

In a preferred embodiment of the present invention, the enhanced post body further has an anti-rotation portion for preventing the enhanced post body from rotating in the first containing portion and the second containing portion, wherein the anti-rotation portion is a serration, a cut slot, a thread, a groove, a protrusion, a through hole or an embossing.

In a preferred embodiment of the present invention, the enhanced post body further has an anti-pull portion for preventing the enhanced post body from being separated upwardly from the first containing portion and the second containing portion, wherein the anti-pull portion is a serration, a cut slot, a thread, a groove, a protrusion, a through hole or an embossing.

In a preferred embodiment of the present invention, the first material is a fiberglass material or a carbon fiber material.

In a preferred embodiment of the present invention, the first material is transparent.

In a preferred embodiment of the present invention, the enhanced post body is installed in the first containing portion and the second containing portion by a hot-melting, snap-in or press-fit method.

In a preferred embodiment of the present invention, the enhanced post body is installed in the first containing portion and the second containing portion by an insert molding method.

In a preferred embodiment of the present invention, the enhanced post body has a shoulder disposed at the enhanced head of the enhanced post body, and the shoulder is contained in the first containing portion and abutted against the operating portion.

In a preferred embodiment of the present invention, the second containing portion is interconnected with the second end of the thread, so that the enhanced post body is protruded from the second end of the thread.

In addition, the present invention further provides a high-strength capped screw made of a composite material, comprising the aforementioned screw made of a high-strength composite material and a cap, wherein the cap is disposed on the head of the screw made of a high-strength composite material and the cap is made of the first material.

In a preferred embodiment of the present invention, the cap has a first stop portion disposed on an inner side of the cap.

In a preferred embodiment of the present invention, the high-strength capped screw made of a composite material further comprises a sleeve, and a second stop portion disposed on an outer side of the sleeve and movably interfered with the first stop portion to movably limit the sleeve at the thread of the high-strength capped screw made of a composite material.

In a preferred embodiment of the present invention, the high-strength capped screw made of a composite material further comprises a rod with a first end, a second end and a receiving channel interconnected with the first end and the second end, wherein the second end of the head is coupled to the first end of the rod, and the second end of the rod is coupled to the first end of the thread, and the first containing portion, the receiving channel and the second containing portion form a space, and the rod is made of the first material, and the enhanced post body is contained in the first containing portion, the receiving channel and the second containing portion.

In a preferred embodiment of the present invention, the high-strength capped screw made of a composite material further comprises a sleeve having a third stop portion disposed on an outer side of the sleeve and movably interfered with the thread to movably limit the sleeve at the rod of the high-strength capped screw made of a composite material.

In a preferred embodiment of the present invention, the high-strength capped screw made of a composite material further comprises a sleeve having a gasket installed on an inner side of the sleeve and movably interfered with the thread to movably limit the sleeve at the rod of the high-strength capped screw made of a composite material.

In addition, the present invention further provides a high-strength capped screw made of a composite material, comprising a screw made of a high-strength composite material, which is the aforementioned screw made of a high-strength composite material; a rod, having a first end, a second end and a receiving channel interconnected with the first end and the second end, and the second end of the head being coupled to the first end of the rod, and the second end of the rod being coupled to the first end of the thread, and the first containing portion, the receiving channel and the second containing portion forming a space, and the rod being made of the first material, and the enhanced post body being contained in the first containing portion, the receiving channel and the second containing portion; and a sleeve, having a third stop portion disposed on an inner side of the sleeve and movably interfered with the thread to movably limit the sleeve at the rod of the high-strength capped screw made of a composite material.

In a preferred embodiment of the present invention, the high-strength capped screw made of a composite material further comprising a cap disposing on the head of the screw made of a high-strength composite material.

In summation, the screw made of a high-strength composite material of the present invention adopts the design of the enhanced post body to increase the strength of the joint between the head and the thread of the screw and to enhance the overall structural strength of the screw, so as to prevent the screw from being damaged, cracked or broken easily.

### BRIEF DESCRIPTION OF THE DRAWINGS

FIGS. 1 to 13 are schematic views of various screws made of a high-strength composite material according to different preferred embodiments of the present invention respectively;

FIGS. 14 to 22 are schematic views of various enhanced post bodies according to different preferred embodiments of the present invention respectively;

FIG. 23 is a schematic view showing the status of a screw made of a high-strength composite material of the present invention being illuminated by an LED, provided that the first material is transparent; and

FIGS. 24 to 28 are schematic views of various high-strength capped screws made of a composite material according to different preferred embodiments of the present invention respectively.

### DETAILED DESCRIPTION OF THE PREFERRED EMBODIMENTS

The objects, characteristics and effects of the present invention will become apparent with the detailed description of the preferred embodiments and the illustration of related drawings as follows.

With reference to FIGS. 1 to 13 for the schematic views of various screws made of a high-strength composite material according to different preferred embodiments of the present invention respectively, FIG. 1 illustrates the first preferred embodiment of the screw made of a high-strength composite material of the present invention, wherein the screw made of a high-strength composite material 1001 comprises a head 100, a thread 200 and an enhanced post body 300.

The head 100 has a first end 101, a second end 102, and a first containing portion 103 (which is a slot) disposed in the head 100, wherein an opening of the first containing portion 103 is formed at the second end 102 of the head 100, and the head 100 is made of a first material which is plastic, fiber, rubber or silicone, and the first material includes a fiberglass material or carbon fiber material.

The thread 200 has a first end 201, a second end 202, and a second containing portion 203 (which is a slot) disposed in the thread 200, wherein an opening of the second containing portion 203 is formed at the first end 201 of the thread 200, and the first end 201 of the thread 200 is coupled to the second end 102 of the head 100, and the first containing portion 103 of the head 100 and the second containing portion 203 of the thread 200 form a space, and the thread 200 is made of the first material, and the head 100 and the thread 200 are integrally formed.

The enhanced post body 300 is installed in the first containing portion 103 and the second containing portion 203 by a hot-melting, snap-in or press-fit method or the first material is covered onto the enhanced post body 300 already installed in the first containing portion 103 and the second containing portion 203 by an insert molding method, and the enhanced post body 300 is made of a second material which is a metal.

In summation, the design of having the first containing portion 103 and the second containing portion 203 contained in the enhanced post body 300 can increase the strength of the joint between the head 100 and the thread 200 of the screw made of a high-strength composite material 1001. When a user turns the screw made of a high-strength composite material 1001, the screw made of a high-strength composite material 1001 will not be damaged, cracked or broken easily.

With reference to FIG. 2 for the second preferred embodiment of a screw made of a high-strength composite material of the present invention, the design of the screw made of a high-strength composite material 1002 is substantially the same as the design of the screw made of a high-strength composite material 1001, wherein the head 100 further includes an operating portion 104 disposed at the top of the head 100 to allow a user to insert a screwdriver to turn the screw made of a high-strength composite material 1002.

With reference to FIG. 3 for the third preferred embodiment of a screw made of a high-strength composite material of the present invention, the design of the screw made of a high-strength composite material 1003 is substantially the same as the design of the screw made of a high-strength composite material 1002, wherein the operating portion 104 is interconnected to the first end 101 and the first containing portion 103 of the head 100. This design can prevent the operating portion 104 from being damaged easily. In addition, when the operating portion 104 is interconnected to the first end 101 and the first containing portion 103 of the head 100, the enhanced post body 300a further comprises an anti-pull portion 304 for preventing the enhanced post body 300 from being separated upwardly from the operating portion 104 away from the first containing portion 103 and the second containing portion 203. The anti-pull portion 304 is a serration, a cut slot, a thread, a groove, a protrusion, a through hole, or an embossing. In FIG. 3, the anti-pull portion 304 is the embossing, and the anti-pull portion 304 is disposed on a surface of the enhanced post body 300.

With reference to FIG. 4 for the fourth preferred embodiment of a screw made of a high-strength composite material of the present invention, the design of the screw made of a high-strength composite material 1004 is substantially the same as the design of the screw made of a high-strength composite material 1003, wherein the screw made of a high-strength composite material 1004 further comprises a rod 400 having a first end 401, a second end 402, and a receiving channel 403 interconnected with the first end 401 and the second end 402, and the second end 102 of the head 100 is coupled to the first end 401 of the rod 400, and the second end 402 of the rod 400 is coupled to the first end 201 of the thread 200, and the first containing portion 103, the receiving channel 403 and the second containing portion 203 form a space, and the rod 400 is made of the first material, and the enhanced post body 300 is contained in the first containing portion 103, the receiving channel 403 and the second containing portion 203. Wherein, the head 100, the rod 400 and the thread 200 are integrally formed.

With reference to FIG. 5 for the fifth preferred embodiment of a screw made of a high-strength composite material of the present invention, the design of the screw made of a high-strength composite material 1005 is substantially the same as the design of the screw made of a high-strength composite material 1005, wherein the enhanced post body 300b further includes an enhanced head 301 disposed at the top of the enhanced post body 300b and contained in the first containing portion 103. This design can enhance the joint between the head 100 and the thread 200 of the screw made of a high-strength composite material 1005. In addition, the second containing portion 203 is interconnected with the second end 202 of the thread 200, such that the enhanced post body 300b is protruded from the second end 202 of the thread 200.

With reference to FIG. 6 for the sixth preferred embodiment of a screw made of a high-strength composite material of the present invention, the design of the screw made of a high-strength composite material 1006 is substantially the same as the design of the screw made of a high-strength composite material 1003, wherein as shown FIGS. 6 and 14, the enhanced post body 300c further includes an enhanced head 301 disposed at the top of the enhanced post body 300c and contained in the first containing portion 103. In addition, the enhanced head 301 further includes an enhanced operating portion 302 disposed at the top of the enhanced head 301 to allow user to insert a screwdriver to turn the screw made of a high-strength composite material 1006. When the enhanced post body 300c has the enhanced operating portion 302, the enhanced post body 300c further includes an anti-rotation portion 303 for preventing the enhanced post body 300c from turning in the first containing portion 103 and the second containing portion 203′. The anti-rotation portion 303 is a serration, a cut slot, a thread, a groove, a protrusion, a through hole, or an embossing, wherein the anti-rotation portion 303 as shown in FIG. 6 is a thread, and the anti-rotation portion 303 is disposed on a surface of the enhanced post body 300. In addition, the screw made of a high-strength composite material 1006 further comprises the rod 400, and the enhanced post body 300 is contained in the first containing portion 103, the receiving channel 403′ and the second containing portion 203′.

With reference to FIG. 7 for the seventh preferred embodiment of a screw made of a high-strength composite material of the present invention, the design of the screw made of a high-strength composite material 1007 is substantially the same as the design of the screw made of a high-strength composite material 1006, wherein the enhanced head 301 of the enhanced post body 300d is disposed in the operating portion 104. In addition, the anti-rotation portion 303 of the enhanced post body 300d is a cut slot, and the anti-rotation portion 303 and the second containing portion 203″ are engaged with each other to prevent the enhanced post body 300d from rotating in the first containing portion 103 and the second containing portion 203″.

With reference to FIG. 8 for the eighth preferred embodiment of a screw made of a high-strength composite material of the present invention, the design of the screw made of a high-strength composite material 1008 is substantially the same as the design of the screw made of a high-strength composite material 1006, wherein as shown in FIGS. 8 and 15, the enhanced head 301 of the enhanced post body 300e is protruded from the first end 101 of the head 100. In addition, the enhanced post body 300e also has the anti-rotation portion 303 and two other anti-pull portions 304, and the anti-rotation portion 303 is in the shape of a long strip and disposed at the second containing portion 203, so that the enhanced post body 300e can be prevented from rotating in the first containing portion 103 and the second containing portion 203 effectively. The anti-pull portions 304 are a serration and a groove respectively, and they are disposed in the first containing portion 103, so that the enhanced post body 300e can be prevented from being separated upwardly from the operating portion 104 and away from the first containing portion 103 and the second containing portion 203.

With reference to FIG. 9 for the ninth preferred embodiment of a screw made of a high-strength composite material of the present invention, the design of the screw made of a high-strength composite material 1009 is substantially the same as the design of the screw made of a high-strength composite material 1004, wherein as shown in FIGS. 9 and 16, the enhanced post body 300f further includes an enhanced operating portion 302 disposed at the top of the enhanced post body 300f, and the enhanced operating portion 302 is disposed in the first containing portion 103, and the anti-rotation portion 303 and the anti-pull portions 304 are embossing. This design can protect the enhanced operating portion 302 and prevent the enhanced post body 300f from rotating in the first containing portion 103 and the second containing portion 203 effectively as well as preventing the enhanced post body 300f from being separated upwardly from the operating portion 104 and away from the first containing portion 103 and the second containing portion 203.

With reference to FIG. 10 for the tenth preferred embodiment of a screw made of a high-strength composite material of the present invention, the design of the screw made of a high-strength composite material 1010 is substantially the same as the design of the screw made of a high-strength composite material 1009, wherein the enhanced operating portion 302 of the enhanced post body 300f is disposed in the operating portion 104.

With reference to FIG. 11 for the eleventh preferred embodiment of a screw made of a high-strength composite material of the present invention, the design of the screw made of a high-strength composite material 1011 is substantially the same as the design of the screw made of a high-strength composite material 1010, wherein the enhanced operating portion 302 of the enhanced post body 300f is protruded from the first end 101 of the head 100.

With reference to FIG. 12 for the twelfth preferred embodiment of a screw made of a high-strength composite material of the present invention, the design of the screw made of a high-strength composite material 1012 is substantially the same as the design of the screw made of a high-strength composite material 1007, wherein as shown in FIGS. 12 and 19, the anti-rotation portion 303 of the enhanced post body 300i is disposed at the enhanced head 301, and the anti-rotation portion 303 is a serration. This design can prevent the enhanced post body 300i from rotating in the first containing portion 103 and the second containing portion 203. The anti-pull portion 304 of the enhanced post body 300i is a through hole, so that if a user covers the first material onto the enhanced post body 300i already installed in the first containing portion 103 and the second containing portion 203 by an insert molding method, the first material will be filled up in the anti-pull portion 304 to achieve the anti-pull effect. In addition, the enhanced post body 300i has a shoulder 305 disposed at the enhanced head 301 of the enhanced post body 300i, and both tops of the shoulder 305 and the enhanced head 301 are in the stepped shape, wherein the shoulder 305 is contained in the first containing portion 103 and abutted against the operating portion 104. This design can prevent the enhanced post body 300i from being pulled out, so as to achieve the anti-pull effect.

With reference to FIG. 13 for the thirteenth preferred embodiment of a screw made of a high-strength composite material of the present invention, the design of the screw made of a high-strength composite material 1013 is substantially the same as the design of the screw made of a high-strength composite material 10073, wherein as shown in FIGS. 13 and 20, the enhanced post body 300j also has the anti-rotation portion 303 and the anti-pull portion 304. The anti-rotation portion 303 is a cut slot disposed at the enhanced head 301, and thus the enhanced post body 300j can be prevented from rotating in the first containing portion 103 and the second containing portion 203. Te anti-pull portion 304 is a thread disposed in the second containing portion 203′, so that the enhanced post body 300j can be prevented from being separated upwardly from the operating portion 104 and away from the first containing portion 103 and the second containing portion 203′.

With reference to FIGS. 17, 18, 21 and 22 for other preferred embodiments of a screw made of a high-strength composite material of the present invention, the enhanced post body 300g as shown in FIG. 17 has the enhanced head 301, the enhanced operating portion 302 and the anti-rotation portion 303, wherein the anti-rotation portion 303 is in the shape of a long strip. In FIG. 18, the enhanced post body 300h has the enhanced head 301, the enhanced operating portion 302, the anti-rotation portion 303 and the anti-pull portion 304, wherein the anti-rotation portion 303 is in the shape of a long strip, and the anti-pull portion 304 is a groove. In FIG. 21, the design of the enhanced post body 300k is substantially the same as the design of the enhanced post body 300c, wherein the enhanced post body 300k has a shoulder 305 disposed at the enhanced head 301 of the enhanced post body 300k, and both tops of the shoulder 305 and the enhanced head 301 form a bevel. Although not shown in the figure, the shoulder 305 is contained in the first containing portion 103 and abutted against the operating portion 104. This design can prevent the enhanced post body 300k from being pulled out, so as to achieve the anti-pull effect. In FIG. 22, the design of the enhanced post body 3001 is substantially the same as the design of the enhanced post body 300i, wherein both tops of the shoulder 305 and the enhanced head 301 of the enhanced post body 3001 form an arc shape. Although not shown in the figure, the shoulder 305 is contained in the first containing portion 103 and abutted against the operating portion 104. This design can prevent the enhanced post body 3001 from being pulled out, so as to achieve the anti-pull effect. Although not shown in the figure, the shoulder 305 can be in other shapes.

In FIG. 23, a user can pass any one of the aforementioned screws made of a high-strength composite material through a first hole 21 formed on a first board 20, and then secured to a second hole 31 of a second board 30, and an LED light source 10 is projected from the bottom of the thread 200. Since the first material of the screw made of a high-strength composite material is a transparent or semi-transparent material, therefore the light emitted from the LED light source 10 can pass through the thread 200 and the head 100 to light up the screw made of a high-strength composite material for different applications such as an alarm.

With reference to FIGS. 24 to 28 for the schematic views of various preferred embodiments of the high-strength capped screws made of a composite material of the present invention, the high-strength capped screw made of a composite material comprises any one type of the aforementioned screws made of a high-strength composite material and a cap 500.

In FIG. 24, the cap 500 of the high-strength capped screw made of a composite material 2001 is disposed on the head 100 of the screw made of a high-strength composite material, and the cap 500 is made of the first material. Wherein, the cap 500, the head 100 and the thread 200 are integrally formed. In addition, the cap 500 and the head 100 are integrally formed or coupled by an insert molding, hot-melting, snap-in or press-fit method (not shown in the figure).

In FIG. 25, the design of the high-strength capped screw made of a composite material 2002 is substantially the same as the design of the high-strength capped screw made of a composite material 2001, wherein the cap 500 further includes a first stop portion 501 disposed on an inner side of the cap 500. In addition, the high-strength capped screw made of a composite material 2003 further comprises a sleeve 600 having a second stop portion 601 disposed on an outer side of the sleeve 600 and movably interfered with the first stop portion 501 of the cap 500, so that the sleeve 600 is movably limited at the thread 203 of the high-strength capped screw made of a composite material 2003.

In FIG. 26, the design of the high-strength capped screw made of a composite material 2003 is substantially the same as the design of the high-strength capped screw made of a composite material 2001, wherein the high-strength capped screw made of a composite material 2003 further comprises a rod 400 having a first end 401, a second end 402, and a receiving channel 403 interconnected with the first end 401 and the second end 402, and the second end 102 of the head 100 is coupled to the first end 401 of the rod 400, and the second end 402 of the rod 400 is coupled to the first end 201 of the thread 200, and the first containing portion 103, the receiving channel 403 and the second containing portion 203 form a space, and the rod 400 is made of the first material, and the enhanced post body 300 is contained in the first containing portion 103, the receiving channel 403 and the second containing portion 203.

In FIG. 27, the design of the high-strength capped screw made of a composite material 2004 is substantially the same as the design of the high-strength capped screw made of a composite material 2001, wherein the high-strength capped screw made of a composite material 2004 has the rod 400, and the high-strength capped screw made of a composite material 2004 further comprises a sleeve 600, and a third stop portion 602 disposed on an inner side of the sleeve 600 and movably interfered with the top of the thread 200, so that the sleeve 600 is movably limited at the rod 400 of the high-strength capped screw made of a composite material 2004.

In FIG. 28, the design of the high-strength capped screw made of a composite material 2005 is substantially the same as the design of the high-strength capped screw made of a composite material 2004, wherein the sleeve 600 has a gasket 603 disposed on an inner side of the sleeve 600 and movably interfered with the thread 200, so that the sleeve 600 is movably limited at the rod 400 of the high-strength capped screw made of a composite material 2004.

In summation of the description above, the present invention provides various screws made of a high-strength composite material and high-strength capped screws made of a composite material. The present invention adopts the design of the enhanced post body to increase the strength of the joint between the head and the thread of the screw made of a high-strength composite material and enhance the overall structural strength of the screw, so as to prevent the screw made of a high-strength composite material from being damaged, cracked or broken easily.

While the invention has been described by means of specific embodiments, numerous modifications and variations could be made thereto by those skilled in the art without departing from the scope and spirit of the invention set forth in the claims.

What is claimed is:

1. A screw made of a high-strength composite material, comprising:
a head, with a first end, a second end, and a first containing portion disposed in the head, and an opening of the first containing portion being formed at the second end of the head, and the head being made of a first material which is plastic, fiber, rubber and or silicone;
a thread, with a first end, a second end, and a second containing portion disposed in the thread, and an opening of the second containing portion being formed at the first end of the thread, and the first end of the thread being coupled to the second end of the head, and the first containing portion of the head and the second containing portion of the thread forming a space, and the thread being made of the first material; and
an enhanced post body, contained in the first containing portion and the second containing portion, and made of a second material which is metal.

2. The screw made of a high-strength composite material according to claim 1, wherein the head further includes an operating portion disposed at the top of the head.

3. The screw made of a high-strength composite material according to claim 2, wherein the operating portion is interconnected with the first end and the first containing portion of the head.

4. The screw made of a high-strength composite material according to claim 1, further comprising a rod with a first end, a second end, and a receiving channel interconnected with the first end and the second end, and the second end of the head being coupled to the first end of the rod, and the second end of the rod being coupled to the first end of the thread, and the first containing portion, the receiving channel and the second containing portion forming a space, and the rod being made of the first material, and the enhanced post body being contained in the first containing portion, the receiving channel and the second containing portion.

5. The screw made of a high-strength composite material according to claim 1, wherein the enhanced post body further includes an enhanced head disposed at the top of the enhanced post body, and the enhanced head is disposed inside the first containing portion.

6. The screw made of a high-strength composite material according to claim 2, wherein the enhanced post body further includes an enhanced head disposed at the top of the enhanced post body, and the enhanced head is disposed inside the first containing portion.

7. The screw made of a high-strength composite material according to claim 3, wherein the enhanced post body further includes an enhanced head disposed at the top of the enhanced post body, and the enhanced head is disposed inside the first containing portion, disposed inside the operating portion, or protruded from the first end of the head.

8. The screw made of a high-strength composite material according to claim 7, wherein the enhanced head further comprises an enhanced operating portion disposed at the top of the enhanced head.

9. The screw made of a high-strength composite material according to claim 3 wherein the enhanced post body further comprises an enhanced operating portion disposed at the top of the enhanced post body.

10. The screw made of a high-strength composite material according to claim 8, wherein the enhanced operating portion is disposed in the first containing portion, disposed inside the operating portion or protruded from the first end of the head.

11. The screw made of a high-strength composite material according to claim 1, wherein the enhanced post body further has an anti-rotation portion for preventing the enhanced post body from rotating in the first containing portion and the second containing portion.

12. The screw made of a high-strength composite material according to claim 11, wherein the enhanced post body further has an anti-pull portion for preventing the enhanced post body from being separated upwardly from the first containing portion and the second containing portion.

13. The screw made of a high-strength composite material according to claim 1, wherein the first material is a fiberglass material or a carbon fiber material.

14. The screw made of a high-strength composite material according to claim 1, wherein the first material is transparent.

15. The screw made of a high-strength composite material according to claim 1, wherein the enhanced post body is installed in the first containing portion and the second containing portion by a hot-melting, snap-in or press-fit method.

16. The screw made of a high-strength composite material according to claim 1, wherein the enhanced post body is installed in the first containing portion and the second containing portion by an insert molding method.

17. The screw made of a high-strength composite material according to claim 7, wherein the enhanced post body has a shoulder disposed at the enhanced head of the enhanced post body, and the shoulder is contained in the first containing portion and abutted against the operating portion.

18. The screw made of a high-strength composite material according to claim 1, wherein the second containing portion is interconnected with the second end of the thread, so that the enhanced post body is protruded from the second end of the thread.

19. A high-strength capped screw made of a composite material, comprising a screw made of a high-strength composite material according to claim 1 and a cap installed to the head of the screw made of a high-strength composite material.

20. The high-strength capped screw made of a composite material according to claim 19, wherein the cap has a first stop portion disposed on an inner side of the cap.

21. The high-strength capped screw made of a composite material according to claim 20, further comprising a sleeve having a second stop portion disposed on an outer side of the sleeve and movably interfered with the first stop portion to movably limit the sleeve at the thread of the high-strength capped screw made of a composite material.

22. The high-strength capped screw made of a composite material according to claim 19, further comprising a rod with a first end, a second end and a receiving channel interconnected with the first end and the second end, and the second end of the head being coupled to the first end of the rod, and the second end of the rod being coupled to the first end of the thread, and the first containing portion, the receiving channel and the second containing portion forming a space, and the rod being made of the first material, and the enhanced post body being contained in the first containing portion, the receiving channel and the second containing portion.

23. The high-strength capped screw made of a composite material according to claim 22, further comprising a sleeve having a gasket installed on an inner side of the sleeve and movably interfered with the thread to movably limit the sleeve at the rod of the high-strength capped screw made of a composite material.

24. A high-strength capped screw made of a composite material, comprising:
a screw made of a high-strength composite material, which is the screw made of a high-strength composite material according to claim 1;
a rod, having a first end, a second end and a receiving channel interconnected with the first end and the second end, and the second end of the head being coupled to the first end of the rod, and the second end of the rod being coupled to the first end of the thread, and the first containing portion, the receiving channel and the second containing portion forming a space, and the rod being made of the first material, and the enhanced post body being contained in the first containing portion, the receiving channel and the second containing portion; and
a sleeve, having a third stop portion disposed on an inner side of the sleeve and movably interfered with the thread to movably limit the sleeve at the rod of the high-strength capped screw made of a composite material.

25. The high-strength capped screw made of a composite material according to claim 24, further comprising a cap disposing on the head of the screw made of a high-strength composite material.
